(19) United States
(12) Patent Application Publication
(10) Pub. No.: US 2009/0177866 A1
(43) Pub. Date: Jul. 9, 2009

(54) SYSTEM AND METHOD FOR FUNCTIONALLY REDUNDANT COMPUTING SYSTEM HAVING A CONFIGURABLE DELAY BETWEEN LOGICALLY SYNCHRONIZED PROCESSORS

(76) Inventors: Michael L. Choate, Round Rock, TX (US); Mark D. Nicol, Austin, TX (US); Michael T. Clark, Austin, TX (US); Scott A. White, Austin, TX (US); Gregory A. Lewis, Austin, TX (US); Todd Foster, Austin, TX (US); Gerald D. Zuraski, JR., Austin, TX (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/970,793

(22) Filed: Jan. 8, 2008

(51) Int. Cl. G06F 9/30

(52) U.S. Cl. 712/200

(57) ABSTRACT

A method of operating a computer system. A first processor sends a first unit of binary information to an input/output (I/O) unit. The I/O unit then conveys the first unit of binary information to a functional unit in the computer system. A system response from the functional unit is then received by the I/O unit, which forwards the system response to the first processor. The system response is also stored in a first buffer. After a predetermined delay time has elapsed, the system response is then forwarded to the second processor.

### BACKGROUND OF THE INVENTION

1. Field of the Invention

This invention relates to computer systems, and more particularly to functionally redundant computer systems as well as their use in a testing environment.

2. Description of the Related Art

Functionally redundant computer systems are well known in the art, and have a wide variety of applications. Functional redundancy may be implemented in computer systems requiring a high degree of reliability, such as in fault tolerant computer systems. A fault tolerant computer system utilizing functional redundancy typically includes two or more processors. Each of the processors operates in synchronous functional lockstep, i.e. each processor receives the same inputs, and is expected to provide the same outputs. Comparators (sometimes referred to as voting circuits) compare outputs from the processors. The comparator can detect a mismatch between the outputs of the two or more processors, and, depending on the configuration of the system, determine which of the processors has provided the correct output.

Functionally redundant computer systems such as those described above may also be useful in a test environment. For example, a system for testing a processor may be designed where a processor is tested by comparing its responses with a known good processor. A detected mismatch between processor outputs may indicate a fault in the processor that is undergoing test. The test system may also be configured to capture the state data at the time of the failure, which may be useful in determining its cause. Test systems utilizing functional redundancy may be useful in both development and manufacturing environments.

### SUMMARY OF THE INVENTION

A method of operating a computer system is disclosed. In one embodiment, a first processor sends a first unit of binary information to an input/output (I/O) unit. The I/O unit then conveys the first unit of binary information to a functional unit in the computer system. A system response from the functional unit is then received by the I/O unit, which forwards the system response to the first processor. The system response is also stored in a first buffer. After a predetermined delay time has elapsed, the system response is then forwarded to the second processor.

In one embodiment, the first and second units of binary information may include commands, data signals, test pins/signals which represent internal processor state and/or address signals, as well as combinations thereof. The units of binary information may be in various formats, such as packets, frames, signal pins or other format supported by the communications protocols in the system.

The system is configured such that the first and second processors, when functioning properly, operate in logical lockstep. That is, the first and second processors produce identical first and second sequences of events (or processor states), respectively. The second sequence of events on one of the processors is delayed relative to the first sequence of events by the predetermined delay time.

A computer system is also contemplated. The computer system includes a first processor, a second processor, and an I/O unit. The computer system may operate in accordance with the method described above, with the first and second processors operating in logical lockstep and with the events of the second processor occurring with a delay relative to equivalent events that occur in the first processor.

The computer system disclosed herein may be a fault tolerant computer system utilizing functionally redundant processors. The system includes at least two functionally redundant processors operating in logical lockstep, with one of the processors operating delayed relative to the other processor.

Because of the redundant configuration, the computer system disclosed herein may also be useful in a test environment for testing microprocessor. Thus, a test system is disclosed. In one embodiment, the test system includes a gold processor that operates with a delay relative to a test processor (i.e. a processor under test). The test processor may initiate transactions, which are conveyed to a system board via an I/O unit. The I/O unit is coupled to receive system responses to the transactions and convey these system responses to the test processor, while also storing the system responses in a first buffer. The I/O unit is configured to convey each system response to the gold processor after a predetermined time delay period has elapsed. For a given system response, the test processor is configured to provide a first unit of binary information, which is stored in a second buffer and subsequently provided to a comparator after the predetermined delay period. The gold processor, after the predetermined delay period, provides a second unit of binary information to a comparator, where it is compared to the first unit of binary information. If a difference is detected between the first and second units of binary information, the comparator produces an indication thereof.

### BRIEF DESCRIPTION OF THE DRAWINGS

Other aspects of the invention will become apparent upon reading the following detailed description and upon reference to the accompanying drawings in which:

FIG. 1 is a block diagram of one embodiment of a computer system with multiple processors;

FIG. 2 is a drawing illustrating the timing of exemplary events during operation of a computer system according to FIG. 1;

FIG. 3 is a flow diagram illustrating the operation of one embodiment of a computer system having at least two processors with one of the processors delayed relative to the other processor(s);

FIG. 4 is a block diagram of one embodiment of a processor test system based on a computer system having two processors with one processor delayed relative to the other; and

FIG. 5 is a flow diagram illustrating the operation of a computer system in order to capture system states in accordance with a trigger event.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling with the spirit and scope of the present invention as defined by the appended claims.

### DETAILED DESCRIPTION OF THE INVENTION

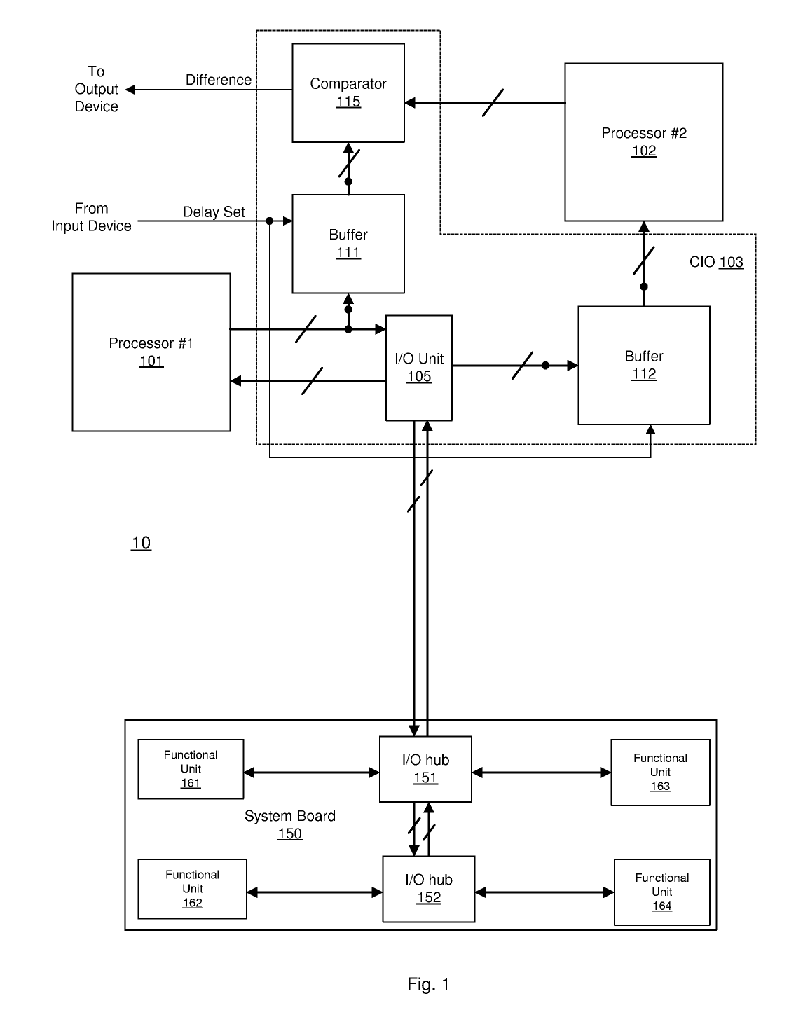

Turning now to FIG. 1, a block diagram of one embodiment of a computer system with multiple processors is shown. In this particular embodiment, computer system 10 includes two processors, processor 101 and processor 102, which are functionally redundant. However, other embodiments having more than two processors are also possible and contemplated. Computer system 10 is configured to operate processors 101 and 102 in logical lockstep with each other, meaning that at, equivalent points in their respective operation, operational states of the processors are expected to be deterministically identical. However, computer system 10 is configured such that processor 102 may operate delayed with respect to processor 101. Alternate embodiments are also possible and contemplated wherein the processor to be delayed is selectable. When operating with a delay between the two processor, a given point of operation (and thus a given processor state), may occur later in processor 102 than the same point of operation (and processor state) occurs in processor 101. The amount of delay between first processor 101 and second processor 102 may be as low as zero (i.e. no delay). The maximum delay for a given embodiment is determined by its particular configuration, and there is no theoretical maximum amount.

Processors 101 and 102 are both coupled to comparator/input/output (CIO) unit 103, which may be implemented as a field programmable gate array (FPGA), application specific integrated circuit (IC), or other suitable means. CIO unit 103 includes an I/O unit 105 that is coupled to both processor 101 and processor 102. In this particular embodiment, I/O unit 105 is a HyperTransport compliant I/O unit, although embodiments using other types of interfaces are also possible and contemplated. CIO unit 103 also includes buffers 111 and 112 and a comparator 115. Buffer 111 is coupled between processor 101 and comparator 115. Buffer 112 is coupled between I/O unit 105 and processor 102. Comparator 115 is coupled to receive information from buffer 111 and processor 102. In the normal operation, the delay setting is 0, and both buffer 111 and 112 apply no delay. In the delay mode of operation, the non-zero delay setting is applied to both buffers 111 and 112.

Computer system 10 also includes system board 150, which includes I/O hubs 151 and 152, as well as functional units 161, 162, 163, and 164. In this embodiment, both of I/O hubs 151 and 152 are HyperTransport I/O hubs capable of transmitting and/or receiving upstream and downstream traffic. Functional units 161-164 may be any of a wide variety of devices that are typically implemented in a computer system. Examples of functional units include devices such as bus host controllers (e.g., a USB host controller), a bus bridge for conveying information to or from another bus (e.g., to a PCI bus), various interface cards implemented in a computer system (e.g., a network interface card), or peripheral devices themselves (e.g., printers, game controllers, etc.). I/O unit 105 is coupled to receive downstream traffic from and convey upstream traffic to both of processors 101 and 102, in accordance with the HyperTransport protocol. When computer system 10 is operating with processor 102 delayed, processor 101 effectively controls the system. During such operation, processor 101 communicates with system board 150 and the various devices thereon through I/O unit 105. Processor 102 is effectively invisible to system board 150 when operating with a delay, as its downstream traffic is ignored by I/O unit 105.

During operation with a delay, upstream traffic to processor 102 is conveyed from I/O unit 105 to buffer 112. In one embodiment, buffer 112 may be a first-in first-out (FIFO) buffer that outputs upstream traffic to processor 102 as new traffic is received from I/O unit 105. The maximum amount of delay possible may be limited by the depth of buffer 112. Thus, various embodiments of computer system 10 can be configured to provide larger delay times by using deeper buffers.

When operating with processor 102 delayed, processor 101 may send traffic downstream to I/O unit 105, which in turn will send the traffic downstream to its destination via I/O hub 151. A response to the downstream traffic may then be sent back upstream to I/O unit 105. The response is provided from I/O unit 105, without delay, to processor 101. At the same time, I/O unit 105 sends the upstream traffic to buffer 112. The upstream traffic is then stored in buffer 112 for a time equal to the predetermined delay time, after which it is provided to processor 102. Responsive to receiving the upstream traffic, processor 101 may send more downstream traffic to I/O unit 105. If both processors are operating in logical lockstep, processor 102 will also send equivalent downstream traffic responsive to the upstream traffic received from the buffer. During operations where processor 102 is delayed, its subsequent downstream traffic is sent to comparator 115 and is ignored (or not received in some embodiments) by I/O unit 105.

The delay setting for Buffer 111 is the same for 112. Buffer 111 sends the delayed downstream traffic from processor 101 to comparator 115. Comparator 115 compares the traffic from buffer 111 to the downstream traffic of processor 102. When the processors are operating in delayed lockstep, the two downstream channels will be identical, and the comparator will not signal a mismatch error until the valid binary units in the channels are different.

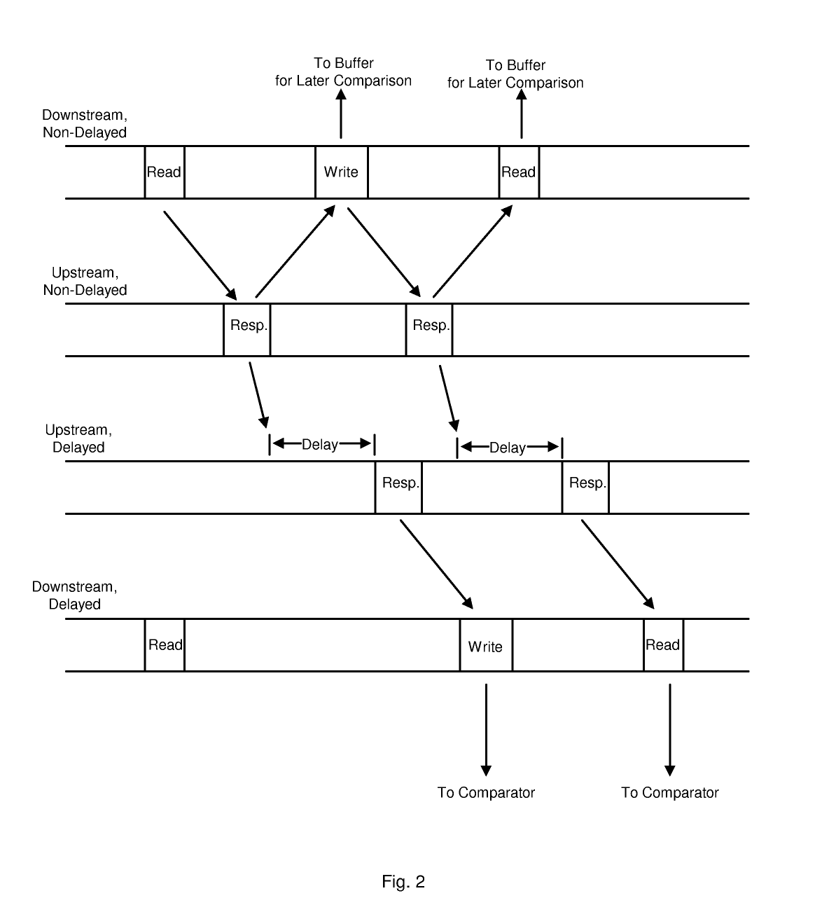

FIG. 2 is a drawing illustrating the timing of exemplary events during operation of a computer system according to FIG. 1. The example shown includes four different traffic paths, or streams: downstream, non-delayed (e.g., from processor 101), upstream, non-delayed (e.g., to processor 101), downstream delayed (e.g., from buffer 111 to comparator 115 AND from processor 102), and upstream, delayed (e.g. from buffer 112 to processor 102).

The example begins with a read transaction initiated in the downstream, non-delayed traffic stream, such as a read transaction initiated by processor 101. A response to the read transaction is then returned upstream, and is provided to processor 101 without delay. This same response is also provided to processor 102 in the upstream delayed path. However, entry into this path is delayed by a predetermined time delay, after which, the response is provided in the upstream delayed path to processor 102.

In this example, upon receiving the response to the initial read transaction, processor 101 may respond by initiating a write transaction in the downstream non-delayed path. Assuming that both processors 101 and 102 are operating in logical lockstep, processor 102 will also respond by initiating a write transaction in the downstream delayed path. The write transaction initiated by processor 102 will be delayed by the same predetermined delay time as response to the previous read transaction.

The write transaction initiated by processor 101 in the downstream non-delayed path then produces another response. This response is conveyed to processor 101 without delay via the upstream, non-delayed path, and to processor 102 after the predetermined delay time has elapsed. When received by processor 101, the response causes another read transaction to be initiated in the downstream non-delayed path. Similarly, the delayed response provided to processor 102 causes a correspondingly delayed read transaction to be initiated in the downstream delayed path.

A cycle of operations similar to the example shown in FIG. 2 will continue as long as processors 101 and 102 are in logical lockstep with each other. Processor 101 may convey units of binary information to I/O unit 105. These units of binary information may include commands, data, address information, and so forth, any may be transmitted in packets, frames, or other structure according to the configuration of the specific embodiment. In general, the binary information may be any information that may be accessed from the processor(s) via output pins or I/O pins.

Processors 101 and 102 must be monitored to ensure they are operating in logical lockstep. In the example of FIG. 2, downstream traffic sent by processor 101 (in the non-delayed path) are additionally conveyed to a buffer for later comparison. Downstream traffic sent by processor 102 (in the delayed path) is sent to a comparator. Returning now to FIG. 1, it can be seen that the downstream connection for processor 101 is coupled to buffer 111 in addition to I/O unit 105. Downstream traffic from processor 101, in addition to being sent to I/O unit 105, is also sent to buffer 111. Like buffer 112, buffer 111 may be a FIFO buffer. Downstream traffic may be stored in buffer 111 for a period equal to the predetermined delay time. After the delay time has elapsed, the downstream traffic is then forwarded to comparator 115. At the same time, downstream traffic from processor 102 is also sent to comparator 115, since the operation of processor 102 lags that of processor 101 by the predetermined delay time. Comparator 115 then performs a comparison operation to determine whether the downstream traffic from processor 101 and the corresponding downstream traffic from processor 102 match. For example, referring momentarily back to FIG. 2, comparator 115 would determine whether the write transaction sent in the non-delayed downstream path (i.e. from processor 101) is the same as the write transaction sent in the delayed downstream path (i.e. from processor 102). In the embodiment shown, if the downstream traffic from processor 101 does not match the corresponding downstream traffic from processor 102, comparator 115 is configured to assert a difference signal. This difference signal may be sent to an output device (e.g., a display) to indicate to a user that the processors are no longer in logical lockstep. Comparisons performed by comparator 115 may be performed on raw binary data, or may be filtered comparisons of only valid command packets.

In addition to providing the difference signal to an output device, this signal may also be provided to functional units within computer system 10. This may allow computer system 10 to respond to the difference accordingly. One embodiment of a computer system is contemplated wherein, if a difference is detected, processor 101 is taken offline and processor 102 assumes the role as the primary processor. In the embodiment shown in FIG. 1, upstream traffic may be sent to processor 102 without delay when the delay is set to zero, while downstream traffic from processor 102 is not ignored by I/O unit 105. Since there is, in this particular scenario, no delay in processor 102 receiving upstream traffic and since I/O unit 105 receives downstream traffic from processor 102 in this situation, processor 102 can assume the role as the primary system processor and interact with system board 150.

Another embodiment is possible and contemplated wherein the computer system includes three or more processors, with one of the processors delayed while the two or more remaining processor operate in synchronous logical lockstep with no delay. In such an embodiment, additional comparators may be implemented to compare the downstream traffic from the delayed processor to that from each of the non-delayed processors. If a difference is detected between the downstream traffic from one of the non-delayed processors relative to the delayed processor, that non-delayed processor may be taken offline while the other processors continue operation. If the processor taken offline was acting as a primary processor, another one of the processors that is still in logical lockstep with the delayed processor may assume that role.

Yet another embodiment is possible and contemplated wherein the computer system is used as a processor test system. One of the processors (e.g., the test processor) may operate without any delay, while the other processor (e.g., a gold processor) operates with a delay. The processors may operate in logical lockstep until an error is detected by detecting a difference in the downstream traffic sent from the processors. The test system may perform additional operations subsequent to detecting the failure in order to obtain more information for analysis purposes. One embodiment of a processor test system based on a multiple processor computer system with one processor delayed relative to the other will be discussed in further detail below.

In the embodiment shown in FIG. 1, setting the predetermined delay may include providing one or more delay set signals to buffers 111 and 112. The delay set signals may indicate the number of clock cycles for which processor 102 is to be delayed relative to processor 101. The number of clock cycles of the predetermined delay may in turn determine the amount of storage allocated in each of buffers 111 and 112. The amount of delay may be set by a user of computer system 10 through an external input device (e.g., a keyboard). In one embodiment, the delay may be set, followed by a reset of processor 101, and, after the predetermined delay period has elapsed, a reset of processor 102. Embodiments are also possible and contemplated wherein the amount of delay may be changed without resetting the system.

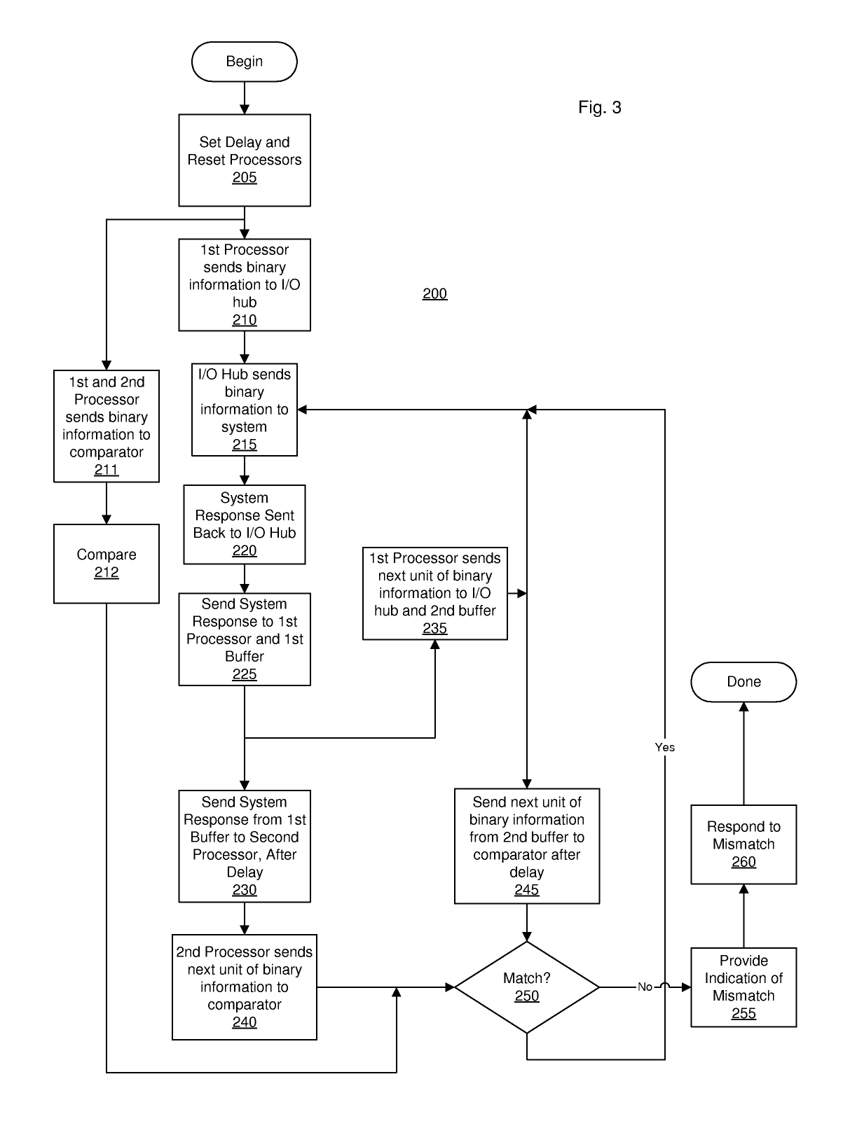

FIG. 3 is a flow diagram illustrating the operation of one embodiment of a computer system having at least two processors with one of the processors delayed relative to the other processor(s). Method 200 begins with the setting of a delay time and the resetting of the (205). The setting of the delay time may specify the number of clock cycles for which operation of a delayed processor lags the one or more non-delayed processors present in the system. The reset procedure includes delaying the reset of the processor which is to operate with a delay relative to the other processor(s) of the system. If the system includes only two processors, the first (non-delayed) processor is reset, followed by the resetting of the second (delayed) processor after the predetermined delay time has elapsed.

After the first processor is initialized, it may send a first unit of binary information to an I/O hub (210). The I/O hub may be similar to I/O unit 105 of FIG. 1, or may be another type of I/O hub depending on the specific implementation. The binary information may include commands, data, address information, and so forth, and may be sent in various formats, such as in a packet or a frame.

The I/O hub may send the binary information downstream to a destination within the computer system (215). The computer system in which the processors are implemented responds to the binary information and sends information corresponding to the response upstream back to the I/O hub (220). The information sent upstream to the I/O hub may include the same types of information as the downstream binary information and may be sent in the same format. For example, the downstream binary information may be a read command, whereas the response sent upstream may be the data that was read responsive to the read command. Upstream data may also include messages (e.g., interrupts) or commands from bus master devices.

After receiving the upstream binary information corresponding to the response from the system, the I/O hub then forwards this information to the first (non-delayed) processor and a first buffer (225). The response is stored in the buffer for the predetermined delay time, and then forwarded to the second (delayed) processor (230).

After receiving the binary information corresponding to the system response, the first processor will then respond thereto by sending a next unit of binary information to both the I/O hub and a second buffer (235). The I/O hub will convey the next unit of binary information downstream within the computer system, while the second buffer will store the next unit of binary information for the predetermined delay time. After the predetermined delay time has elapsed, the second buffer unit sends the next unit of binary information to a comparator (245). Meanwhile, the second (delayed) processor, upon receiving the binary information corresponding to the system response from the first buffer responds by generating another copy of the next unit of binary information (240), assuming both processors are functioning correctly. The next unit of binary information is sent to the comparator (240) at the same time the first buffer sends its copy of the next unit of binary information. The comparator then conducts a comparison of the next unit of binary information received from the first processor (via the second buffer) and the second processor (250).

If the next unit of binary information from the first and second processors match (250, yes), the processors are operating in logical lockstep, and system operation continues unabated. However, if the next unit of binary information from the processors does not match (250, no), it is an indication of a potential fault in the system, and an indication of the mismatch is provided (255). The computer system or a user thereof may then respond to the mismatch (260).

A response to the mismatch may be performed in accordance with the particular embodiment of the computer system. For example, in a system with three or more processors with one delayed processor, a mismatch for one of the non-delayed processor may result in that processor being taken offline. If the processor producing the mismatch is acting as a primary processor, another processor may assume that role. In another embodiment, wherein the computer system is to be used as a microprocessor test system, a mismatch may be indicative of a fault in a non-delayed test processor being compared to a delayed gold processor. Another use of the test system is to recognize a specific event, such as an error from the non-delayed processor, and then to stop and analyze the state of the delayed processor. Such use may include operating the delayed processor from the point the error occurred (in the non-delayed processor) while capturing the successive states, which may include an occurrence of the same error in the delayed processor. These states can be saved for further analysis.

Method 200 also performs a comparison after resetting the processors to ensure they both start in equivalent states. After resetting the processors, the first unit of binary information sent by the first processor to the hub is also sent to the comparator, while the second processor also sends an intended equivalent unit of binary information to the comparator (211). The comparator then compares the first unit of binary information received from the first processor to the first unit of binary information to the second processor (212). If the comparator determines a match (250, yes), the procedure continues as described above for other instances in which comparisons produce a match. Otherwise, if the units of binary information do not match (250, no), an indication of a mismatch is provided, and a subsequent response to a mismatch is performed (260).

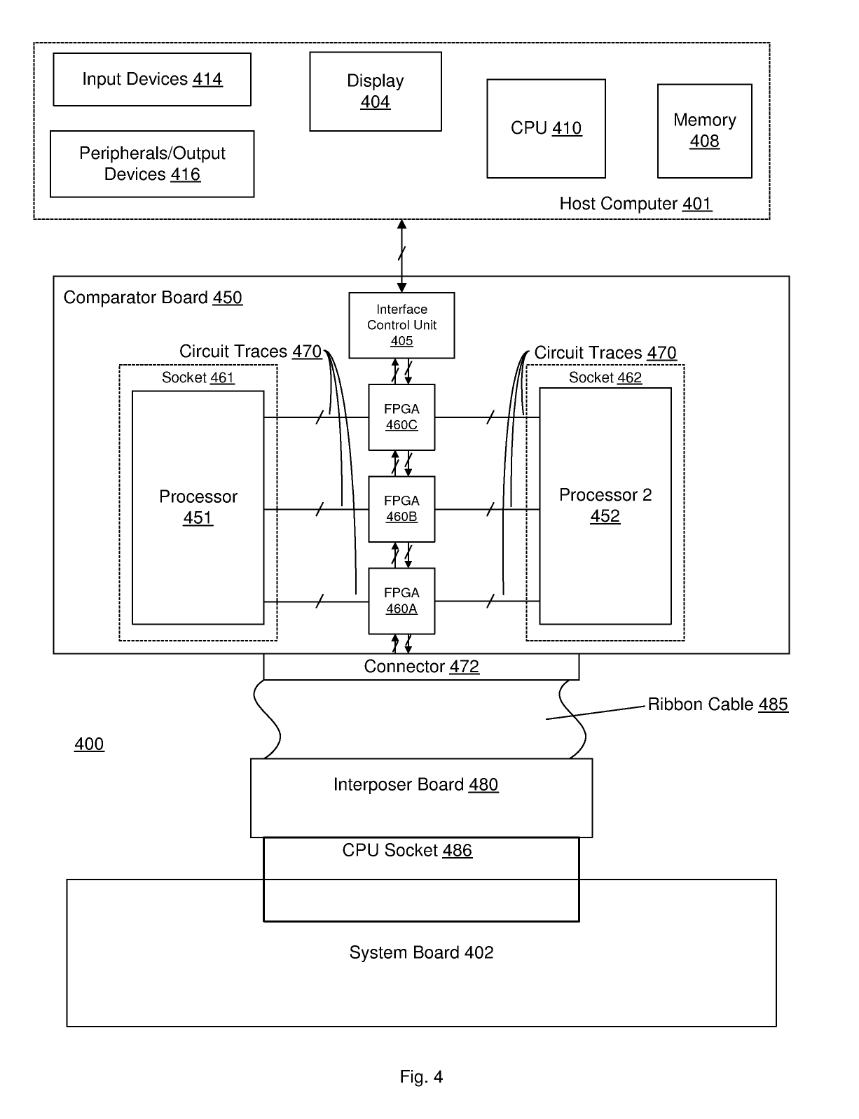

FIG. 4 is a block diagram of one embodiment of a processor test system based on a computer system having two processors with one processor delayed relative to the other. In the embodiment shown, processor test system 400 is configured to operate as a computer system in accordance with the various embodiments described above. More particularly, test system 400 can operate with multiple processors (two, in this particular embodiment), wherein the processors operate in logical lockstep with each other (assuming they are functioning correctly) with one of the processors delayed relative to the other.

Processor test system 400 includes a host computer 401 coupled to a comparator board 450. Host computer 401 is configured to control the test system during test, and includes a CPU 410 that functions separately from the processors involved with the test. A memory subsystem including memory 408 is also included in host computer 410, and provides the random access memory for host computer 401. Memory 408 may be used for, among other thing, storing state data captured from one or both of the processors during operation of test system 400. Furthermore, one of peripherals 416 may include a hard disk that may provide hard storage for captured state data for later use.

Display 404 may allow a user of test system 400 to monitor the testing and any results thereof. Host computer 410 also includes other peripherals and output devices 416, which can be customary computer peripherals such as printers, external storage devices, network interfaces, and so forth. User input to the host computer may be provided through input devices 414, which may include a keyboard, a mouse, a joystick, a touch screen display, and any other device that may enable external inputs to be provided to a computer system.

Processors 451 and 452 are coupled to comparator board 450 via sockets 461 and 462, respectively. Comparator board 450 effectively functions as a processor for a computer system that includes system board 402. System board 402 includes a CPU socket 486, which is coupled to comparator board 450 via interposer board 480, ribbon cable 485, and connector 472 (which is mounted upon comparator board 450). System board 402 may be a typical computer system motherboard, and may also be coupled to various peripheral devices. During operation of test system 400, one of the processors of comparator board 450 communicates with system board (and the various functional units implemented thereon). The other processor may be effectively isolated from the system board, even though the two processors of comparator board 450 are otherwise operating in logical lockstep with each other.

In addition to the two processors and their respective sockets, comparator board 450 includes an interface control unit 405 and a plurality of FPGAs 460A-460C. Interface control unit is configured to provide an interface between host computer system 401 and comparator board 450 as well as the units implemented thereon, including processor 451 and 452. More particularly, a user of test system may enter commands into one or both of the processors via interface control unit 405 and one or more of the FPGAs 460A-460C. Similarly, data from processor 451 and 452 may also be output to host computer system 401 via interface control unit 405.

At least one of FPGAs 460A-460C (if not all of them) may be configured to implement the same functionality as discussed above with regard to CIO 103 of FIG. 1. That is, the at least one FPGA includes an I/O unit, a pair of buffers, and a comparator, and thus provides the functionality to enable the processors to operate in logical lockstep with one processor delayed relative to the other. Alternate embodiments wherein this functionality is implemented using ASICs instead of FPGAs are possible and contemplated.

In one embodiment, each of the FPGAs includes the functionality of CIO 103 of FIG. 1, with the I/O unit in each including a HyperTransport tunnel. Embodiments utilizing other types of communications buses are also possible and contemplated. The FPGAs are coupled to the processors via circuit traces 470, which may be carefully matched in length in order to more precisely control the timing relationships between the processors. In one embodiment, circuit traces 470 coupled between the FPGAs and processor 451 are within 1/1000th of an inch in length with equivalent circuit traces 470 coupled between the FPGAs and processor 452.

It should also be noted that each of FPGAs 460A-460C may also include additional functionality not otherwise discussed. Such functionality may include additional comparators to compare the states of equivalent pins of processors 451 and 452. At least one of FPGAs 460A-460C may include a test access port (TAP) that conforms to the JTAG standard, to enable various test related functions such as the inputting of commands into the processors and accessing various data within the processors (e.g., such as data content stored in processor registers). The TAP port may include separate test data output (TDO) connections that enable data to be accessed from each processor independently of the other processor. The additional functionality that may be implemented in FPGAs 460A-460C may also include additional buffers that are used to capture and store state information from one or both of the processors. Additional comparators that may compare processor outputs and states of I/O pins to each other or to expected output based on other information (such as an expected output to an input command or test vector) may also be included. These additional comparators may be used for monitoring one or both of the processors for the occurrence of various events.

In some embodiments, the processor to be delayed may be selectable, i.e. either the first processor or the second processor may be delayed depending on an operator input. In such embodiments, FPGAs 460A-460C (or their equivalents) may include selection circuitry which allows the selected processor to operate with a delay relative to the non-selected processor.

Test system 400 is capable of supporting a wide variety of test configurations. In one possible configuration, one of the processors acts as a gold (i.e. a known good) processor, while the other processor acts as the device under test, or test processor. The test processor may operate as the primary processor, communicating with system board 402 during test operations. The gold processor may operate in logical lockstep with the test processor but with a delay. Integrity of the test processor may be monitored by comparing its downstream responses to upstream traffic with downstream responses of the gold processor to the same upstream traffic. A difference in downstream responses to upstream traffic may indicate the presence of a fault in the test processor.

In another test configuration, two identical processors may operate with one processor delayed relative to the other, with neither processor being a gold processor. The test system may operate until a failure is detected in the non-delayed processor. In this case, the failure may be detected by other means than the comparators discussed above (e.g., additional comparators coupled to input and/or I/O pins configured to compare a state of processor pins to an expected value based on a test vector). Once the failure is detected, the non-delayed processor may be stopped, and the (now formerly) delayed processor may assume the role as the primary processor. This processor may then operate until an equivalent failure occurs, with state data of the processor being captured for a time period equal to the delay time up until the failure. By gathering state data of a processor leading up to an expected failure, valuable insight may be gained in determining the cause of the failure.

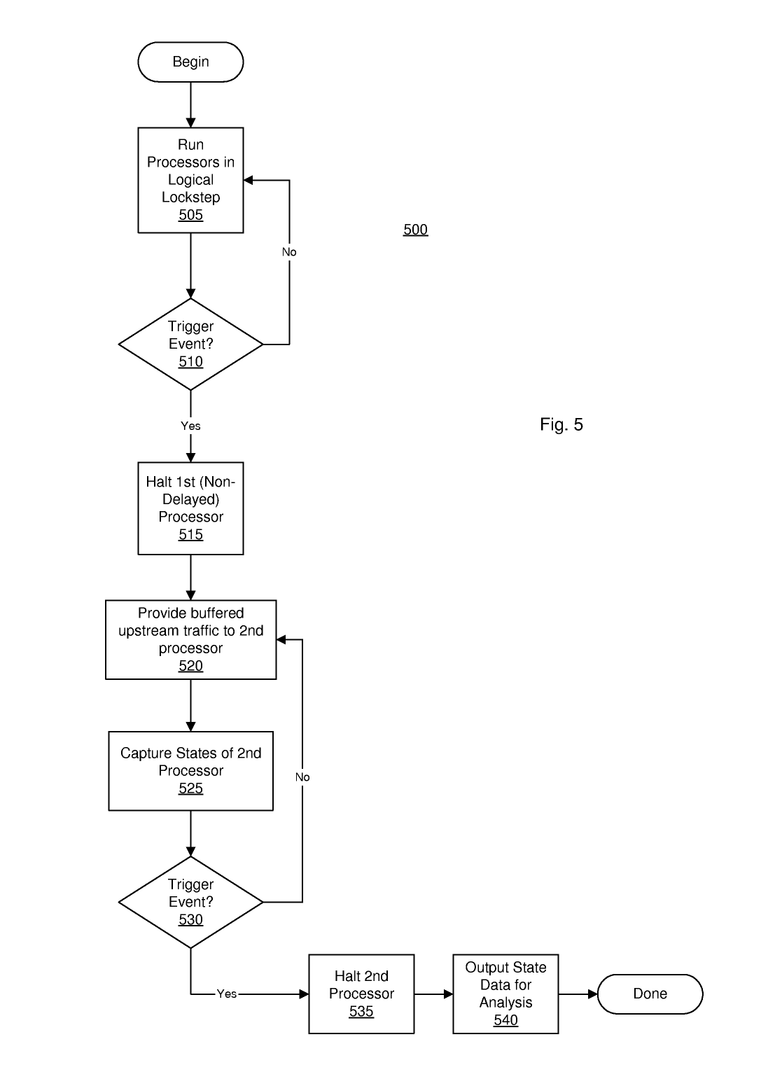

Yet another embodiment may include operations that result in a known trigger event, as will now be discussed in conjunction with FIG. 5. Examples of such a trigger event include unique memory or IO access, execution of program code conditional upon test results, branch taken/not-taken indicators, data pattern(s) accessed or generated by the processor or 10 subsystem, any other sequence of processor or system behavior that can indicate an anomaly, or predetermined processor state that occurs responsive to a known condition. An example of such a condition may be the execution of a given number of iterations of a loop in a software program. The trigger even may be used to initiate a sequence of operations and a corresponding capture of data that can be used to analyze processor operation up to the trigger event. The processors may include a gold processor and a test processor, or may include two identical processors where neither processor is considered a gold processor.

FIG. 5 is a flow diagram illustrating the operation of a computer system in order to capture system states in accordance with a trigger event. In this case, the trigger event may be a predefined event, such as an instruction access occurs only when a known anomaly occurs during the execution of a program. The method described herein can be used for testing a processor, and alternatively, may be used for other activities such as code optimization. This particular example is based on the operation of two identical processors, where neither processor is considered to be a gold processor. However, an alternate example is possible wherein one of the processors is a gold processor.

Method 500 begins with the operation of the computer system with the processors operating in logical lockstep (500). In this embodiment, operation in logical lockstep also includes one of the processors being delayed relative to the other processor, as described above. Operation of the non-delayed processor is monitored for a first occurrence of a trigger event (510). If the trigger event has not occurred (510, no), then operation of the processors, both delayed and non-delayed, continues with the processors remaining in logical lockstep with each other.

Upon occurrence of the first trigger event (510, yes), the first (non-delayed) processor is halted (515). Since the second processor was operating with a delay relative to the first processor, there may be stored within the buffer a number of cycles of upstream traffic that were responses to previously sent downstream traffic from the first processor. The number of cycles may be based on the predetermined delay time.

Operation of the system continues by providing the buffered upstream traffic to the second processor (520). This effectively repeats the operation of the first processor leading to the first occurrence of the trigger event, as the same inputs are provided to the second processor that were previously provided to the first processor. During this time, the states of the second processor may be captured and stored within test system 400 (525). During this portion of the system operation, test system 400 monitors the second processor for an occurrence of the same trigger event that previously occurred in the first processor (530). After the trigger event occurs (530, yes), which is expected based on the previous occurrence in the identical first processor, the second processor is halted (535). Upon halting of the second processor, the captured state data may be output for analysis by a user of the test system (540). In an alternative embodiment of this method, the second processor may be halted before it reaches the equivalent state of the first processor at its corresponding trigger event (i.e. 510) in order to capture operational state information that could otherwise be destroyed by the occurrence of the trigger event. In such a case, the trigger event of 530 (which applies to the second processor) is different from trigger event 510 (which applies to the first processor)

In an alternative embodiment of the method, wherein the first processor is a test processor and the second processor is the gold processor, a second occurrence of the trigger event may not occur if the first occurrence (in the test processor) is due to a fault. In such a case, the second processor may be operated up until the time the trigger event would have occurred if the gold processor had the same fault as the non-delayed test processor. In this embodiment of the method (and others as well), state data may be captured for both the non-delayed test processor as well as for the gold processor. The state data leading up to the trigger event for the test processor may be compared to the state data leading up to the equivalent point of operation for the gold processor (i.e. where the trigger event would have occurred in the gold processor). The state data may then be compared for the two processors, which may provide insight as to why the fault occurred in the test processor. In either of the embodiments described above, the second processor may be operated in a single step mode (i.e. stepping the processor to the next state, temporarily halting the processor to capture the state, stepping to the next state thereafter, and so forth) after the first occurrence of the trigger event 510.

The test system may also be used for other purposes as well. For example, code testing and optimization may be performed using two identical and known good processors in the test system. The software code under test may be executed on the test system, with one processor being delayed relative to the other. The test system may monitor for anomalies and/or sub-optimal performance in the state of the first processor that occur as a result of execution of the code under test. Upon discovering an anomaly, the execution may be repeated on the second processor in accordance with the principles of the test system, with data representing captured processor states provided as an output that may provide insight as to the cause of the anomaly in the software code.

In various embodiments, the test system described herein may be used in a hardware development environment, a manufacturing environment, or any other environment where it might be useful.

More generally, the computer system described herein, in addition to its usefulness as a test system, may also be useful in environments where fault tolerance and/or functional redundancy is required. Due to the fact that the computer system described herein includes two or more functionally redundant processors, a fault in one processor may not cause a halt in system operation. In embodiments including two processors, the delayed processor may be able to assume the role of the primary system processor and may thus allow system operation to continue.

For those embodiments having more than two processors, with one of the processors delayed, the outputs provided by the delayed processor may provide a basis of comparison to determine if the other processors are functioning correctly. If one of the processors is determined to be functioning incorrectly, as detected based on the outputs of the delayed processor, the faulty processor may be taken offline, while the other processors, and thus the system, may continue operation unabated.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method of operating a computer system, the method comprising:
a first processor sending a first unit of binary information to an input/output (I/O) unit;
sending the first unit of binary information from the I/O unit to a functional unit in the computer system;
receiving a system response to the first unit of binary information from the functional unit at the I/O unit;
forwarding the system response to the first processor;
storing the system response in a first buffer; and
forwarding the system response to a second processor after a predetermined delay time has elapsed.

2. The method as recited in claim 1 further comprising:
receiving a second unit of binary information from the first processor;
storing the second unit of binary information in a second buffer;
receiving a third unit of binary information from the second processor one predetermined delay time after receiving the second unit of binary information;
comparing the second unit of binary information to the third unit of binary information; and
providing an indication if the second unit of binary information is different from the third unit of binary information.

3. The method as recited in claim 2 further comprising stopping operation of the first processor if the second unit of binary information does not match the third unit of binary information.

4. The method as recited in claim 1 further comprising:
determining a trigger event;
observing a first occurrence of the trigger event, wherein the first occurrence of the trigger event occurs in the first processor;
capturing a plurality of states of the second processor during the predetermined delay time prior to the trigger event occurring in the second processor responsive to the first occurrence of the trigger event; and
observing the second occurrence of the trigger event, wherein the second occurrence of the trigger event occurs in the second processor.

5. The method as recited in claim 1, wherein the second processor operates in logical lockstep with the first processor, wherein an event that occurs in the first processor occurs in the second processor after the predetermined delay time has elapsed.

6. The method as recited in claim 1, wherein the predetermined delay time is programmable.

7. The method as recited in claim 1 further comprising the first processor controlling a system board of the computer system.

8. The method as recited in claim 1 further comprising initializing the computer system by:
setting the predetermined delay time;
resetting the first processor;
resetting the second processor after the predetermined delay time;
the first processor initiating transactions within the computer system;
the first processor receiving system responses to the transactions; and
the second processor receiving buffered copies of the system responses to the transactions of the first processor after the predetermined delay time.

9. A computer system comprising:
an input/output (I/O) unit, wherein the I/O unit includes a first buffer;
a first processor coupled to the I/O unit; and
a second processor coupled to the I/O unit;
wherein the I/O unit is configured to:
receive a first unit of binary information from the first processor;
convey the first unit of binary information to a functional unit in the computer system;
receive a system response from the functional unit;
convey the system response to the first processor;
store the said system response in a first buffer; and
convey the system response from the first buffer to the second processor after a predetermined delay time has elapsed.

10. The computer system as recited in claim 9, wherein the I/O unit includes a second buffer and a comparator, and wherein the I/O unit is further configured to:
receive a second unit of binary information from the first processor;
store the second unit of binary information in the second buffer;
receive a third unit of binary information from the second processor after one predetermined delay time after receiving the second unit of binary information;
compare the second unit of binary information to the third unit of binary information in the comparator; and
provide an indication if a difference is detected between the second unit of binary information and the third unit of binary information.

11. The computer system as recited in claim 10, wherein the computer system is configured to stop operation of the first processor if the second unit of binary information does not match the third unit of binary information.

12. The computer system as recited in claim 9, wherein the I/O unit is further configured to:
observe a first occurrence of a trigger event, wherein the first occurrence of the trigger event occurs in the first processor;
capturing a plurality of states of the second processor during the predetermined delay time prior to the trigger event occurring in the second processor responsive to the first occurrence of the trigger event; and
observing the second occurrence of the trigger event in the second processor.

13. The computer system as recited in claim 9, wherein the computer system is configured to operate the second processor in logical lockstep with the first processor, wherein an event occurring in the first processor occurs in the second processor after the predetermined delay time has elapsed.

14. The computer system as recited in claim 9, wherein the predetermined delay time is programmable.

15. The computer system as recited in claim 9, wherein the computer system further includes a system board, and wherein the system board is controlled by the first processor.

16. The computer system as recited in claim 9, wherein the computer system is configured to perform an initialization routine comprising:
setting the predetermined delay time;
resetting the first processor;
resetting the second processor after the predetermined delay time;
the first processor initiating transactions within the computer system;
the first processor receiving system responses to the transactions; and
the second processor receiving the system responses to the transactions after the predetermined delay time

17. A system for testing a processor, the system comprising:
an input/output (I/O) unit, wherein the I/O unit including a first buffer, a second buffer, and a comparator;
a test processor coupled to the I/O unit; and
a gold processor coupled to the I/O unit;
wherein the I/O unit is configured to:
receive a system response to a transaction initiated by the test processor;
convey the system response to the test processor;
store the system response in a first buffer; and
convey the system response from the first buffer to the gold processor after a predetermined delay period has elapsed;
wherein the test processor is configured to provide a first unit of binary information responsive to receiving the system response, and wherein the I/O unit is configured to store the first unit of binary information in the second buffer; and
wherein the comparator is configured to compare the first unit of binary information to a second unit of binary information provided by the gold processor responsive to the gold processor receiving the system response, wherein the comparator is configured to provide an indication if the first unit of binary information is different from the second unit of binary information.

18. The system as recited in claim 17, wherein the test system is configured to stop the test processor responsive to the comparator detecting a difference between the first and second units of binary information.

19. The system as recited in claim 17, wherein the I/O unit is configured to:
observe a first occurrence of a trigger event, wherein the first occurrence of the trigger event occurs in the test processor;
responsive to the first occurrence of the trigger event, capturing a plurality of states of the gold processor during the predetermined delay time prior to the trigger event occurring in the gold processor;
observing the second occurrence of the trigger event in the gold processor;
outputting the plurality of states.

20. The system as recited in claim 17, wherein the gold processor operates in logical lockstep with the test processor, wherein an event that occurs in the test processor occurs in the gold processor after the predetermined delay time has elapsed.
